(19) United States
(12) Patent Application Publication
(10) Pub. No.: US 2006/0001822 A1
(43) Pub. Date: Jan. 5, 2006

(54) Liquid crystal display apparatus

(76) Inventor: Yutaka Sano, Tottori-shi (JP)

Correspondence Address: KATTEN MUCHIN ROSENMAN LLP, 525 WEST MONROE STREET, CHICAGO, IL, 60661-3693, US

(21) Appl. No.: 11/171,286

(22) Filed: Jul. 1, 2005

(30) Foreign Application Priority Data
Jul. 5, 2004 (JP) 2004-197891

(51) Int. Cl. G02F 1/1345

(52) U.S. Cl. 349/150

(57) ABSTRACT

A liquid crystal display apparatus configured in such manner such that multiple (N, N>2) tape carrier packages (TCPs) respectively mounting liquid crystal driver ICs SD1 to SD6 are disposed on the periphery of a liquid crystal display panel 2, whereby the neighboring TCPs are connected to each other via respective connection wires L1 to L6 formed on the liquid crystal display panel 2 as well as signals and a voltage required for driving the liquid crystal display panel 2 and the liquid crystal driver ICs SD1 to SD6 are supplied by a control circuit 3 to at least one of the TCPs, with the signals and voltage being supplied by the control circuit sequentially to and from the particular TCP are then transmitted to one of the adjacent TCPs, where a serially connected group is configured by serially connecting the N of TCPs and divided into two parts at the center thereof, and the signals and voltage are independently supplied from the control circuit to the two neighboring TCPs on both sides of the location of the division. According to the present invention, it is possible to provide a liquid crystal display apparatus which can reduce unevenness in display quality of the center and peripheral portions of the liquid crystal display panel, utilizing a lesser number of wires between the control circuit board and the liquid crystal display panel.

### CROSS-REFERENCE TO RELATED APPLICATIONS

This application claims priority to Japanese Patent Application No. 2004-197891, filed on Jul. 5, 2004, the contents of which are incorporated herein by reference.

### BACKGROUND OF THE INVENTION

1. Field of the Invention

The present invention relates to a liquid crystal display apparatus, and more particularly to a liquid crystal display apparatus configured in such manner that multiple TCPs (Tape Carrier Packages) mounting respective liquid crystal driver ICs disposed thereon are serially connected and installed on the periphery of a liquid crystal display panel, with the effect of reducing unevenness in the display quality of the central and peripheral portions of the liquid crystal display panel.

2. Description of the Prior Art

The liquid crystal display panel and a control circuit used to drive the display panel of a liquid crystal display apparatus are generally connected to each other via multiple TCPs mounting respective liquid crystal driver ICs disposed thereon. These TCPs, which include multiple source driver TCPs and gate driver TCPs, are connected to a control circuit board, which in turn supplies the respective TCPs with image data signals and a power supply voltage to cause the liquid crystal driver ICs disposed on each TCPs to drive the liquid crystal display panel.

Since the image data signals, the power supply voltage and the like are independently supplied from the control circuit board to the respective TCPs in the liquid crystal display apparatus described above, it is necessary to dispose a large number of wires on the control circuit board, which consequently involves a complicated manufacturing process for the control circuit board, the TCPs, and the liquid crystal display panel, thereby resulting in increased costs, while decreasing the level of reliability (refer to lines 1 to 13 of the bottom right column on page 1 and FIG. 2 of Japanese Laid-Open Patent Publication No. S62-238684 [hereinafter referred to as “Patent Document 1”] and the claims identified as paragraphs [0002] to [0013], and [0043] to [0047], and FIG. 1 of Japanese Laid-Open Patent Publication No. 2001-056481 [hereinafter to as “Patent Document 2”].

In view of the aforementioned problems, a liquid crystal display apparatus employing the so-called signal transmission type has been recently introduced to replace the TCP type described above, which sequentially transmits signals and similar input to and from one TCP to an adjacent TCP, thereby reducing the number of the wires required for the TCPs (refer to Patent Document 2).

A description will now be given of a liquid crystal display apparatus 1A employing the signal transmission type disclosed in Patent Document 2 to facilitate understanding of the present invention in relation to FIG. 3, which is a schematic plane view of the liquid crystal display apparatus disclosed in Patent Document 2.

The liquid crystal display apparatus 1A is provided with an active matrix type liquid crystal display panel 2 on which TFTs (thin film transistors) are installed, a control circuit board 3 disposed adjacent to the periphery of the liquid crystal display panel 2, and multiple (for example, six) source driver circuits ST1 to ST6 individually placed on multiple TCPs connected to the control circuit board 3 are disposed on the periphery of one side of the liquid crystal display panel 2.

The source driver circuits ST1 to ST6 on the corresponding TCPs respectively include source driver ICs SD1 to SD6 signal input wires used to input signals to the source driver IC, first signal output lines used to output signals from the source driver IC to the liquid crystal display panel 2, second signal output lines used to transmit output signals from the source driver IC to the adjacent TCP, a power supply wire used to drive the source driver IC and the like, which are disposed on the respective TCPs.

These multiple source driver circuits ST1 to ST6 are serially connected via respective connection wires L1 to L6, and the first source driver circuit ST1 and the control circuit board 3 are provided on a flexible printed circuit board FPC and connected to each other via a supply line 7 used for the signals and the like. The control circuit board 3 is constituted by an image data signal control IC 5, a power supply circuit 6, and the like. The image data signal control IC 5 processes the image signals transmitted from an image signal generating apparatus such as a PC, which is not shown.

In addition, gate driver circuits (only GT1 is shown in FIG. 3) respectively placed on multiple TCPs are provided on another periphery of the liquid crystal display panel 2, and serially connected likewise, with the first gate driver circuit GT1 being connected to a gate driver IC GD1 via a supply line used for the signals (not shown), and via a flexible printed circuit board.

In the liquid crystal display apparatus 1A provided with the above-described TCPs, if the image data signals, the power supply voltage, and the like are supplied from the control circuit board 3 to the first source driver IC SD1 via the supply line 7 and connection wire L1 (for example), a part of the image data signals would be processed by the source driver IC SD1, and resulting signals are outputted to corresponding source electrodes of respective pixels on the liquid crystal display panel 2, and the rest of the signals, the power supply voltage, and the like are outputted sequentially to the source driver ICs SD2 to SD6 via wires on the TCPs and the connection wires L2 to L6 on the liquid crystal display panel. Similarly, the respective source driver ICs SD2 to SD6 output corresponding image data signals to source electrodes of respective pixels on the liquid crystal display panel 2.

Similarly, on this occasion, a gate control signal is processed by the gate driver IC GD1 on the gate driver circuit GT1 provided on the second periphery of the liquid crystal display panel 2, and resulting signals are outputted to gate electrodes of corresponding pixels on the liquid crystal display panel 2.

Thus, in contrast to the liquid crystal display apparatus using a conventional control circuit board and TCPs, it is possible to lessen by a large number the wires required to supply signals and the like from the control circuit board 3 to the TCPs in the liquid crystal display apparatus 1A, thereby reducing its manufacturing cost.

However, in the liquid crystal display apparatus using TCPs with the above-described configuration, the system of sequentially transmitting the signals and similar input to and from a specific TCP to adjacent TCPs requires longer wires for transmitting the signals, resulting in increased wire resistance.

In addition, because of the large number of wires disposed in the liquid crystal liquid crystal driver ICS such as the source driver ICs and gate driver ICs on the TCPs and the wires used to drive the liquid crystal display panel, the space occupied by the wires used to transmit the signals and the like is thereby restricted. Such limitation leads to increased wire resistance, because it is not possible to increase the width and thickness of the wires, which in turn causes a drop in voltage of the transmitted signals, especially a drop in power supply voltage, leading the liquid crystal driver ICs to malfunction. Namely, the amount of voltage drop gradually increases in the downstream transmission direction, resulting in variances in power supply voltage output from the driver ICs to the liquid crystal display panel between the upstream and the downstream in the serially connected group of TCPs. As a result, even if the same gradation is intended for the entire display area of the liquid crystal display panel, for example, the variation in the gradation between the upstream and the downstream causes a degradation of display quality.

A possible configuration of the liquid crystal display apparatus which may not be attended with the above defects would be such that the serially connected group, configured by serially connecting the multiple TCPs, is divided into two parts at the center, and the image data signals and the like would be supplied in the same direction from one side of the divided serially connected groups of TCPs. For example, as shown in the liquid crystal display apparatus 1B in FIG. 4, a serially connected group configured by serially connecting multiple TCPs is divided into two parts respectively constituting three TCPs at the center, namely a serially connected group constituted by TCPs on which the source driver circuits ST1 to ST3 are respectively formed, and a serially connected group constituted by TCPs on which the source driver circuits ST4 to ST6 are respectively formed. The source driver circuits ST1 and ST4 corresponding to the first TCPs of each of the two serially connected groups are connected to the control circuit board 3 respectively via supply lines 7′ and 7 used for the signals and the like respectively formed on the FPC₂ and FPC₁, thereby supplying the respective source driver circuits ST1 and ST4 with the signals and the like from the control circuit board 3.

Under the liquid crystal display apparatus 1B employing this system, since the serially connected group is divided into two parts, the length of the two groups of serially connected TCPs becomes shorter, thereby reducing the drop in voltage toward the end of each serially connected group, and the number of the image data signals supplied to the respective serially connected groups is halved, thereby exhibiting the additional effect of reduced electromagnetic interference (referred to as EMI hereinafter).

However, comparing the two groups of serially connected TCPs in the liquid crystal display apparatus with the above-described configuration, the wire resistance of the portion adjacent to the source driver circuit ST3 of the TCP located on the center portion of the liquid crystal display panel is greater compared with the wire resistance of the portion in the neighboring source driver circuit ST1, such that the amount of voltage drop in the former portion is higher than that of the latter. On the other hand, there is practically no voltage drop in the neighborhood of the source driver circuit ST4 of the other serially connected group adjacent to the source driver circuit ST3, such that the pixel area having a large drop in power supply voltage and the pixel area having a small drop in power supply voltage thus come into contact with each other along the center portion of the display area of the liquid crystal display panel, which is the most remarkable portion, possibly resulting in uneven display quality thereat. Further, because the control circuit board 3 has to be connected to the source driver circuits ST1 and ST4 of the respective first TCPs of the two groups of serially connected TCPs disposed at separate locations, the control circuit board 3 becomes longer and larger.

Additionally, in the crystal display apparatus described in Patent Document 2, although the arrangement and shape of the signal wires and power supply wires formed on the TCPs are devised so as to decrease their resistance, these measures are not necessarily sufficient.

### SUMMARY OF THE INVENTION

The present invention has been devised to solve the above problems of the prior art, and aims to provide a crystal display apparatus configured in such manner that multiple TCPs respectively mounting liquid crystal driver ICs thereon are serially connected and attached on one periphery of a liquid crystal display panel, a serially connected group being configured by serially connecting the TCPs and divided into two, and image data signals and the like are thereby respectively supplied from one side of each of the two groups of serially connected TCPs, thereby enabling the reduction in uneven display quality of the liquid crystal display apparatus at the center and peripheral portions of the liquid crystal display panel.

The above object of the present invention is attained by the following configurations. Namely, according to the first aspect of the present invention, the liquid crystal display apparatus is configured in such manner that a plurality (N, N>2) of TCPs respectively mounting liquid crystal driver ICs thereon are disposed on one periphery of a liquid crystal display panel, the neighboring TCPs being connected to each other via connection wires respectively formed on the liquid crystal display panel, whereby signals and the voltage required for driving the liquid crystal display panel and the liquid crystal driver ICs are supplied by a control circuit to at least one of several TCPs, and the signals and voltage are supplied from such TCP to which the signals and voltage are supplied by the control circuit sequentially to one of the adjacent TCPs, where a serially connected group configured by serially connecting the N of TCPs is divided into two parts at the center thereof, and the signals and voltage supplied from the control circuit are supplied independently to two of the TCPs neighboring each other on both sides of the location of the division.

Preferably, according to this aspect of the invention, the transmission order of the signals supplied to the two TCPs on each side of the divided location from the control circuit is set to a transmission order in the forward direction for the first of the two TCPs and to a transmission order in the reverse direction for the second of the two TCPs, and further, a timing controller including a line memory and a bus driver serving as a directional switch is provided between the control circuit and the second of the two TCPs, and the timing controller converts the transmission order of the signal transmitted from the control circuit in the forward direction to the reverse direction.

Moreover, according to the second aspect of the present invention, the liquid crystal display apparatus is configured in such manner that a plurality (N, N>2) of TCPs respectively mounting liquid crystal driver ICs thereon are disposed on one periphery of the liquid crystal display panel, the neighboring TCPs being connected to each other via respective connection wires formed on the liquid crystal display panel, whereby signals and the voltage required for driving the liquid crystal display panel and the liquid crystal driver ICs are supplied by a control circuit to at least one of several TCPs, and the signals and voltage are supplied from the TCP to which the signal and voltage are supplied by the control circuit sequentially to one of the adjacent TCPs, where a serially connected group configured by serially connecting the N of TCPs is divided into two parts at the center thereof, and the signals and voltage supplied from the control circuit are supplied independently to two of the TCPs neighboring each other on both sides of the location of the division, and one or two FPCs used to connect the control circuit and the liquid crystal display panel with each other are disposed at the center of the periphery of the liquid crystal display panel.

Preferably, according to this aspect of the invention, the transmission order of the signals supplied to the two of the TCPs neighboring each other on each side of the divided location from the control circuit is set to a transmission order in the forward direction for the first of the two TCPs and to a transmission order in the reverse direction for the second of the two TCPs, and further, a timing controller including a line memory and a bus driver serving as a directional switch is provided between the control circuit and the second of the two TCPs, and the timing controller converts the transmission order of the signal transmitted from the control circuit in the forward direction to the reverse direction.

The present invention configured in the manner described above provides the following excellent effects. Namely, with respect to the first aspect thereof, the serially connected group being configured by serially connecting the multiple TCPs and divided into two parts at the center, the two respective groups of serially connected TCPs become shorter in length, while the signals and the like are independently supplied from the control circuit to the two of the TCPs neighboring each other on each side of the location of the division so that the drops in voltage at the end of each of the two serially connected groups decrease, making the amounts of voltage drops practically equal, thereby eliminating the likelihood of occurrence of uneven display at the center portion of the liquid crystal display panel, which happens to be the most remarkable portion thereof, while at the same time reducing the probability of uneven display occurring at the peripheral portion of the liquid crystal display panel. Moreover, since the control circuit is connected to the two neighboring TCPs at the divided location, it is not necessary to extend the wires to the ends of the liquid crystal display panel, thereby making it possible to reduce the size of the large control circuit board. Further, since the serially connected group is configured by serially connecting the multiple TCPs and divided into two parts at the center, the number of image data signals respectively supplied to the two serially connected groups of TCPs decreases, resulting in EMI reduction.

In this case, if the serially connected group is configured by serially connecting the TCPs and divided into two parts at the center, and the signals from the control circuit are simply independently supplied to the respective liquid crystal driver ICs on the two adjacent TCPs on each side of the divided location, although the signals supplied to the first of these TCPs are transmitted in order in the forward direction, the signals supplied to the second of these TCPs are transmitted in order in the opposite direction, such that the image display is not carried out normally for the other side. However, the image display can be carried out normally for the other group of TCPs by inverting the transmission order of the signals supplied to the other TCP to the reverse direction. In addition, it is possible to invert the transmission order of the signals supplied to the other TCP by means of a simple constitution in the form of a timing controller with a line memory and a bus driver serving as a bidirectional switch.

Moreover, in addition to the advantages presented by the first aspect of the invention, according to the second aspect thereof, since the TCPs are adjacent to each other on each side of the divided location, the connection to the control circuit can be realized by one FPC or two short FPCs, and the wires can be readily connected.

### BRIEF DESCRIPTION OF THE DRAWINGS

FIG. 1 is a schematic plane view showing a liquid crystal display apparatus according to an embodiment of the present invention.

FIG. 2 is a timing chart showing the timing relationship among the signals DATA1 to DATA3 referred to in FIG. 1.

FIG. 3 is a schematic plane view showing connections between a liquid crystal display panel and source driver circuits constituting a liquid crystal display apparatus of prior art.

FIG. 4 is a schematic plane view showing connections between a liquid crystal display panel and source driver circuits constituting another liquid crystal display apparatus of the prior art.

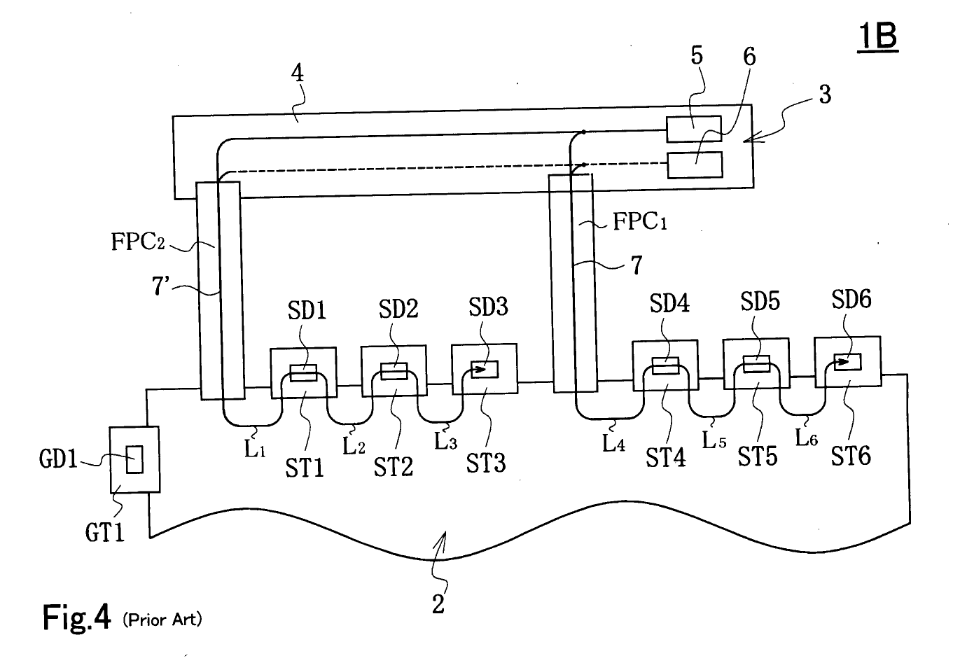

### DETAILED DESCRIPTION OF THE PREFERRED EMBODIMENTS

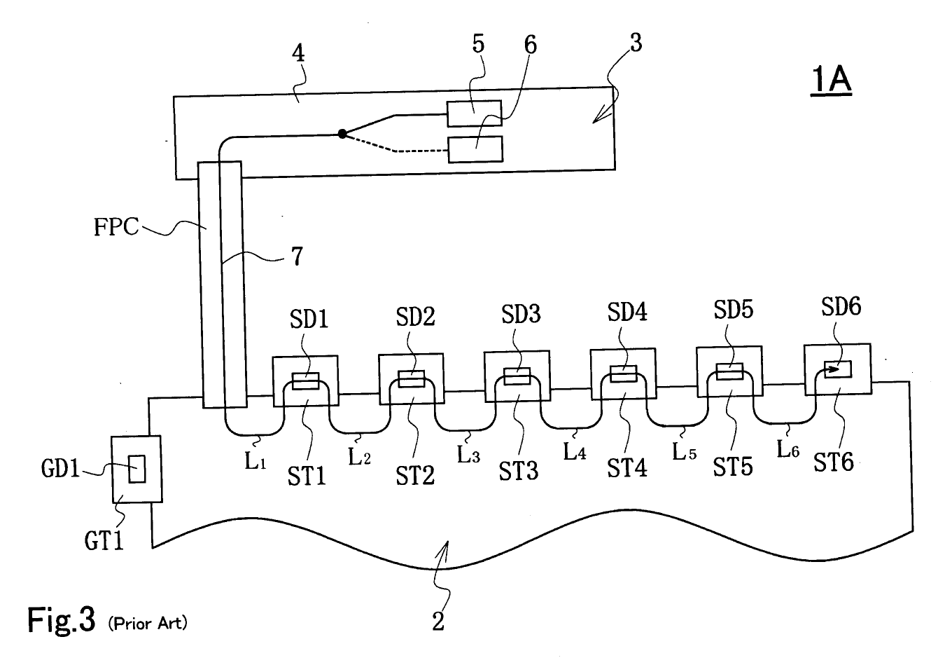

A detailed description will now be given of an embodiment of the liquid crystal display apparatus according to the present invention with reference to accompanying drawings. While the embodiment described below shows an example of a liquid crystal display apparatus embodying technical ideas of the present invention, such description is not intended to restrict the application of the present invention, which is equally applicable to other embodiments within the scope of the claims. In the description written below, elements of the liquid crystal display apparatus of the present invention which correspond to those of the conventional liquid crystal display apparatus shown in FIG. 3 bear the same reference numerals.

### Embodiment 1

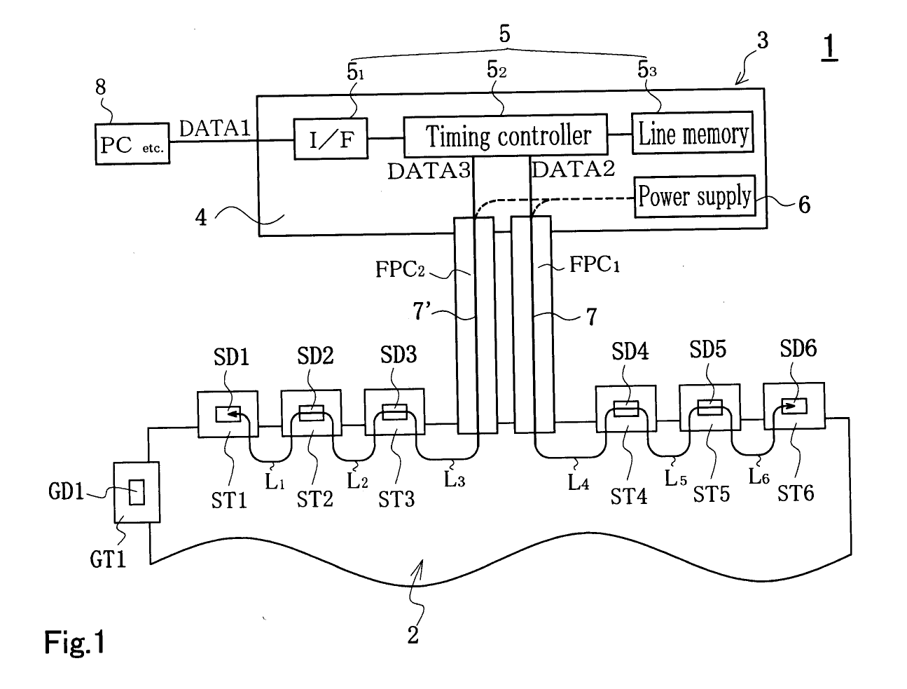

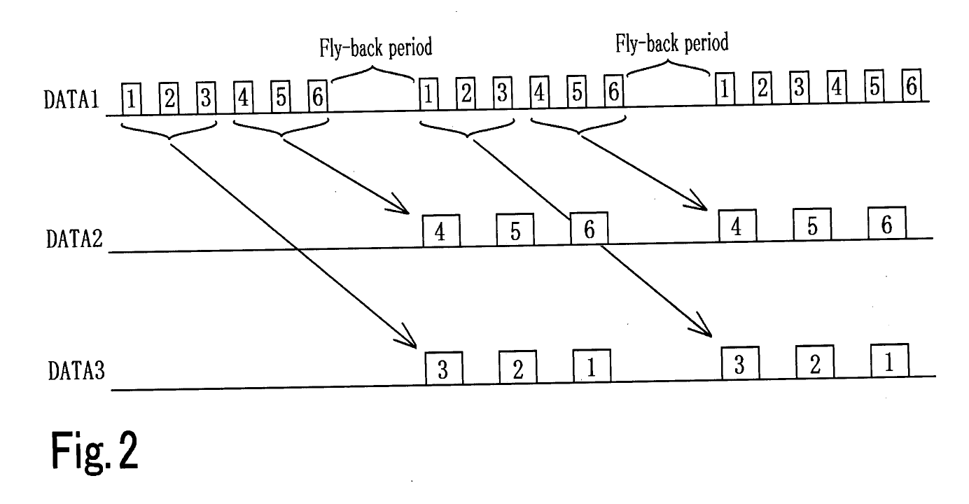

FIG. 1 is a schematic plane view showing a liquid crystal display apparatus according to the embodiment of the present invention, while FIG. 2 is a timing chart showing the timing relationship among the signals DATA1 to DATA3 referred to in FIG. 1. The configuration of the liquid crystal display apparatus 1 shares a lot of common aspects with that of the conventional liquid crystal display apparatus 1A shown in FIG. 3, but differs with the latter in the following respects:

(1) A serially connected group is configured by serially connecting N (N>2, N=6 herein) of TCPs and divided into two parts at the center, whereby one serially connected group is constituted by three TCPs on which source driver circuits ST1 to ST3 are respectively formed, and the other serially connected group is constituted by three TCPs on which source driver circuits ST4 to ST6 are respectively formed, and the respective adjacent driver circuits ST3 and ST4 at the divided location are connected to a control circuit board 3 via signal lines 7 and 7′ formed respectively on FPC₁ and FPC₂, and

(2) A control IC 5 installed on the control circuit board 3 is provided with an interface 5₁, a timing controller 5₂ including a bus driver serving as a directional switch, and a line memory 5₃.

Namely, in the conventional liquid crystal display apparatus 1A shown in FIG. 3, image data signals transmitted from an image data signal generating apparatus such as a PC are sequentially transmitted as pulse signals corresponding to data 1 up to data 6 respectively corresponding to source driver ICs SD1 to SD6 represented as DATA1 in FIG. 2. The pulse signals corresponding to data 1 up to data 6 are controlled by independent timing pulses, not shown, such that the pulse signal corresponding to data 1 is supplied to the source driver IC SD1, and the pulse signal corresponding to data 2 is supplied to the source driver IC SD2, for example, thereby being sequentially supplied to source lines of respective pixels corresponding to the source driver IC SD1 to SD6 on the liquid crystal display panel 2. Although the pulse signals corresponding to data 1 to data 6, inclusive, actually include pulse trains corresponding to the number of source lines of the liquid crystal display panel respectively connected to the source driver ICs SD1 to SD6, only one pulse is illustrated as the pulse signal to simplify the description as shown in FIG. 2.

If the signals represented as DATA1 in FIG. 2 are simply inputted to the liquid crystal display apparatus 1 according to the present embodiment, the signals are transmitted to the source driver ICs SD1 to SD3 in the opposite order, although the signals are transmitted to the source driver ICs SD4 to SD6 in the correct order. Accordingly, with respect to the source driver ICs SD4 to SD6, since the pulse signals corresponding to data 4, data 5, and data 6 are sequentially supplied in the correct order to the source driver ICs SD4, SD5, and SD6, respectively, a correct display is carried out on either the left or right half portion of the liquid crystal display apparatus. However, with respect to the source driver ICs SD1 to SD3, since the pulse signals corresponding to data 1, data 2, and data 3 are sequentially supplied in the opposite order to the source driver ICs SD3, SD2, and SD1, respectively, a correct display is not carried out on either the left or the right half portion of the liquid crystal display apparatus.

In the present embodiment, the control IC 5 installed on the control circuit board 3 includes the interface 5₁, the timing controller 5₂ including the bus driver serving as the directional switch, and the line memory 5₃. The image data signals DATA1 transmitted from the image data signal generating apparatus 8 such as a PC are temporarily stored into the line memory 5₃ via the timing controller 5₂. With respect to the source driver ICs SD4 to SD6, image data signals DATA2 including data 4, data 5, and data 6 in this forward order as shown in FIG. 2 are then supplied to the source driver IC SD4 via the timing controller 5₂ and the supply line 7 on the FPC₁. With respect to the source driver ICs SD1 to SD3, image data signals DATA3 including data 3, data 2, and data 1 in this reverse order as shown in FIG. 2 are then supplied to the source driver IC SD3 via the timing controller 5₂ and the supply line 7′ on the FPC₂.

As a result, the pulse signals corresponding to data 1, data 2, and data 3 are supplied to the source driver ICs SD1, SD2, and SD3, respectively, and correct display is thus achieved across the entire display area of the liquid crystal display panel 2.

Note that, on the timing controller 5₂ including the bus driver serving as directional switch, the circuit which transmits data in the forward order to the source driver ICs SD4 to SD6 is widely known to those skilled in the art as a “queue” (also referred to as FIFO, the acronym for fast-in, fast-out), and the circuit which transmits data in the reverse order to the source driver ICs SD1 to SD3 is widely known as a “stack” (also referred to as FILO, the acronym for first-in, last-out).

In addition, in the present embodiment, since the serially connected group is configured by serially connecting the multiple TCPs of the liquid crystal display panel 2 and divided into two parts at the center, the resulting two serially connected groups become shorter in length. Moreover, since the signals and the like are independently supplied from the control circuit 5 to the two neighboring source driver ICs SD3 and SD4 located on opposite sides of the division, the voltage drops down to the source driver ICs SD1 and SD6 respectively disposed at the end of each of the two serially connected groups decreases, such that the amounts of voltage drops practically become equal. Consequently, the probability of the occurrence of uneven display is eliminated on the center portion of the liquid crystal display panel 2, which is the most remarkable portion, while the probability of the occurrence of uneven display on the peripheral portion thereof decreases.

Moreover, since the control IC 5 is connected to the two neighboring source driver ICs SD3 and SD4 at the divided location, it is not necessary to extend the wires to the ends of liquid crystal display panel, thereby making it possible to reduce the size of the control circuit board 3. Further, since the serially connected group is configured by serially connecting the multiple TCPs and divided into two parts at the center, the number of data signals respectively supplied to the two serially connected groups and represented as DATA2 and DATA3 in FIG. 2, is halved. Moreover, since these halved data signals can be transmitted within one scan period, the pulse width can thus be increased, resulting in a large reduction of EMI.

Note likewise that although the present embodiment features the control IC 5 installed on the control circuit board 3 as incorporative of the interface 5₁, the timing controller 5₂ including the bus driver serving as the directional switch, and the line memory 5₃ to supply the image data to the driver ICs SD4 to SD6 in the forward order and to the driver ICs SD1 to SD3 in the reverse order, it would be possible to simply supply the signals to the driver ICs SD1 to SD3 without inverting the order, if an image data signal generating apparatus 8 such as a PC which can generate signals in the reverse direction for the driver ICS SD1 to SD3 in advance, is employed. In addition, in the present embodiment, two independent FPCs, FPC₁ and FPC₂ are respectively used as the FPC which connects the liquid crystal display panel 2 and the control circuit board 3, but since the distance between both FPCs is short, the two may be combined into one FPC.

What is claimed is:

1. A liquid crystal display apparatus configured in such manner that a plurality (N, N>2) of tape carrier packages (referred to as TCPs hereinafter) mounting a liquid crystal driver IC thereon are disposed on the periphery of a liquid crystal display panel, the said neighboring TCPs being connected via a connection wire formed on the said liquid crystal display panel, a signal and a voltage required for driving said liquid crystal display panel and the said liquid crystal driver ICs are supplied by a control circuit to at least one of the said TCPs, and the signal and voltage are supplied from such TCP to which the signal and voltage are supplied by the said control circuit sequentially to a TCP adjacent thereto, wherein:
a serially connected group is configured by serially connecting the said N of TCPs and divided into two parts at the center thereof, and the signal and voltage supplied from the said control circuit are supplied independently to two of the said neighboring TCPs located on opposite sides of the division.

2. The liquid crystal display apparatus according to claim 1, wherein the transmission order of the signals supplied to the said two neighboring TCPs on opposite sides of the divided location from the said control circuit is set in the forward direction for one of the said two TCPs and in the reverse direction for the other TCP.

3. The crystal display apparatus according to claim 2, wherein a timing controller comprising a line memory and a bus driver serving as a directional switch is provided between the said control circuit and the said other TCP, and the said timing controller converts the transmission order of the signal transmitted from the said control circuit in the forward direction to the reverse direction.

4. A liquid crystal display apparatus configured in such manner that a plurality (N, N>2) of tape carrier packages (referred to as TCPs hereinafter) mounting a liquid crystal driver IC thereon are disposed on the periphery of a liquid crystal display panel, the said neighboring TCPs being connected via a connection wire formed on the said liquid crystal display panel, a signal and a voltage required for driving said liquid crystal display panel and the said liquid crystal driver ICs are supplied by a control circuit to at least one of the said TCPs, and the signal and voltage are supplied from such TCP to which the signal and voltage are supplied by the said control circuit sequentially to a TCP adjacent thereto, wherein:
a serially connected group is configured by serially connecting said N of TCPs and divided into two parts at the center thereof, and the signal and voltage supplied from the said control circuit are supplied independently to the two neighboring TCPs on opposite sides of the divided location and one or two flexible printed circuit boards used to connect the said control circuit and the said liquid crystal display panel with each other are disposed at the center of the periphery of the said liquid crystal display panel.

5. The liquid crystal display apparatus according to claim 4, wherein the transmission order of signals supplied to the said two neighboring TCPs on opposite sides of the divided location from the said control circuit is set in the forward direction for one of the said two TCPs while the transmission order for the other TCP is set in the reverse direction.

6. The crystal display apparatus according to claim 5, wherein a timing controller comprising a line memory and a bus driver serving as a directional switch is provided between the said control circuit and the said other TCPs, and the said timing controller converts the transmission order of the signal transmitted from said control circuit in the forward direction to the reverse direction.
